(19) United States
(12) Patent Application Publication
(10) Pub. No.: US 2005/0047629 A1
(43) Pub. Date: Mar. 3, 2005

(54) System and method for selectively expanding or contracting a portion of a display using eye-gaze tracking

(75) Inventors: Stephen P. Farrell, San Francisco, CA (US); Shumin Zhai, San Jose, CA (US)

Correspondence Address: SAMUEL A. KASSATLY LAW OFFICE, 20690 VIEW OAKS WAY, SAN JOSE, CA, 95120, US

(73) Assignee: International Business Machines Corporation, Armonk, NY (US)

(21) Appl. No.: 10/648,120

(22) Filed: Aug. 25, 2003

(51) Int. Cl. G06K 9/00

(52) U.S. Cl. 382/117; 382/116; 382/103

(57) ABSTRACT

A computer-driven system amplifies a target region based on integrating eye gaze and manual operator input, thus reducing pointing time and operator fatigue. A gaze tracking apparatus monitors operator eye orientation while the operator views a video screen. Concurrently, the computer monitors an input indicator for mechanical activation or activity by the operator. According to the operator's eye orientation, the computer calculates the operator's gaze position. Also computed is a gaze area, comprising a sub-region of the video screen that includes the gaze position. The system determines a region of the screen to expand within the current gaze area when mechanical activation of the operator input device is detected. The graphical components contained are expanded, while components immediately outside of this radius may be contracted and/or translated, in order to preserve visibility of all the graphical components at all times.

### FIELD OF THE INVENTION

The present invention generally relates to gaze tracking systems and interactive graphical user interfaces. More particularly, the present invention relates to a system for selectively expanding and/or contracting portions of a video screen based on an eye-gaze, or combination of data from gaze tracking and manual user input.

### BACKGROUND OF THE INVENTION

In human-computer interaction, one of the most basic elements involves selecting a target using a pointing device. Target selection is involved in opening a file with a mouse “click”, activating a world wide web link, selecting a menu item, redefining a typing or drawing insertion position, and other such operations. Engineers and scientists have developed many different approaches to target selection. One of the most popular target selection devices is the computer mouse. Although computer mice are practically essential with today's computers, intense use can be fatiguing and time consuming.

Despite these limitations, further improvement of mouse-activated target selection systems has been difficult. One interesting idea for possible improvement uses eye gaze tracking instead of mouse input. There are several known techniques for monitoring eye gaze. One approach senses the electrical impulses of eye muscles to determine eye gaze. Another approach magnetically senses the position of special user-worn contact lenses having tiny magnetic coils. Still another technique, called “corneal reflection”, calculates eye gaze by projecting an invisible beam of light toward the eye, and monitoring the angular difference between pupil position and reflection of the light beam.

With these types of gaze tracking systems, the cursor is positioned on a video screen according to the calculated gaze of the computer operator. A number of different techniques have been developed to select a target in these systems. In one example, the system selects a target when it detects the operator fixating at the target for a certain time. Another way to select a target is when the operator's eye blinks.

One problem with these systems is that humans use their eyes naturally as perceptive, not manipulative, body parts. Eye movement is often outside conscious thought, and it can be stressful to carefully guide eye movement as required to accurately use these target selection systems. For many operators, controlling blinking or staring can be difficult, and may lead to inadvertent and erroneous target selection. Thus, although eye gaze is theoretically faster than any other body part, the need to use unnatural selection (e.g., by blinking or staring) limits the speed advantage of gaze controlled pointing over manual pointing.

Another limitation of the foregoing systems is the difficulty in making accurate and reliable eye tracking systems. Only relatively large targets can be selected by gaze controlling pointing techniques because of eye jitter and other inherent difficulties in precisely monitoring eye gaze. One approach to solving these problems is to use the current position of the gaze to set an initial display position for the cursor (reference is made, for example, to U.S. Pat. No. 6,204,828).

The cursor is set to this initial position just as the operator starts to move the pointing device. The effect for this operation is that the mouse pointer instantly appears where the operator is looking when the operator begins to move the mouse. Since the operator needs to look at the target before pointing at it, this method effectively reduces the cursor movement distance.

According to the well-known Fitts′ law, human control movement time is as follows:
T=a+b log 2(D/W+1),
where a and b are constant, and D and W are target distance and size respectively. The value for log2 (D/W+1) is also known as the index of difficulty. Consequently, reducing D reduces the difficulty of pointing at the target. This approach is limited in that the behavior of the mouse pointer is noticeably different for the operator when this system is used.

One object of conventional systems has been to increase the speed at which a user can acquire a target, i.e., move a mouse or other cursor over an interactive graphical user interface (GUI) element or button. The time that it takes to acquire the target is governed by Fitts' law and is proportional to the distance from where the cursor initially is to the target and inversely proportional to the size of the target. It takes less time to acquire the target if the target is larger, and less time if the distance is smaller. Fitts' law suggests that improving the speed with which a target is acquired can be accomplished by either increasing the size of the target or reducing the distance to the target.

Previous systems have decreased the time required to acquire the target by decreasing the distance. Information from a gaze-tracking device determines where on the screen the eye is currently looking. Distance is decreased by jumping or “warping” the pointer or cursor to the position currently viewed. The user wishes to click on a button, looks at the button, and starts to move the mouse cursor. Previous systems recognize that the user is gazing at a button and moving the cursor. In response, it warps the cursor over to the button's location.

Another conventional approach to ease target acquisition expands the size of a target when the mouse is moved over it. This expansion is used by several modern graphical user interfaces such as MacOSX® and KDE®. In this application, the depiction on the screen is being expanded but the actual position where the mouse pointer is moved over, does not change. While the button appears to be larger or bigger, the amount of the button available for interaction or clicking does not increase. If the user moves the cursor to the part that is newly visible and enlarged, the enlarged portion actually disappears. The motor dimension has not changed; only the visual dimension has changed. This approach does not improve the speed of target acquisition because what matters is the dimension in the physical motor space, not the visual perception of the object.

Studies have shown that target expansion is a very effective method for making a pointing task easier. It has been found that even if a target is expanded just before the cursor approaches it (e.g., after 90% of the entire movement distance), the user could still take almost full advantage of the increased target size. The effect is as if the target size were constantly large. The size of the target is effectively increased, hence reducing the difficulty of pointing at the target according to Fitts' law. The difficulty with the previous efforts on target expansion is that the computer system has to predict which object is the intended target. Predicting the intended target is extremely difficult to do based on the cursor motion alone.

What is therefore needed is a method for increasing the size of an object to reduce the time required to acquire a target, i.e., move a pointer to an interactive GUI object such as a button. The need for such a system has heretofore remained unsatisfied.

### SUMMARY OF THE INVENTION

The present invention satisfies this need, and presents a system, a computer program product, and an associated method (collectively referred to herein as “the system” or “the present system”) for selectively expanding and/or contracting a portion of a display using eye-gaze tracking to increase the ability to quickly acquire or click on the target object. When an object in a display is expanded, some of the display is lost. The present system manages the screen display to accommodate that loss with minimum loss of information or function to the user.

When a user gazes at a graphical element such as a button, the present system changes the size of the actual button in the physical motor domain, making the button visually and physically larger. This object expansion is based on eye-gaze tracking. In contrast to conventional systems, the present system actually increases the size of the target instead of reducing the distance to the target.

The present system requires a computer graphical user interface and a gaze-tracking device. When a user wishes to acquire a target, he or she first looks at that target, and then starts to move the cursor toward it. In the case of a touch screen, the user would use a stylus, finger, or other such device. Upon the conjunction of these events, the system increases the size of the target by a predetermined ratio. The expansion occurs when the computer system detects the events of the user's action towards an object that is being viewed.

When there are multiple adjacent targets below the gaze tracking resolution, the present system expands adjacent objects within the gaze spot and lets the user choose his or her intended target. The gaze spot is typically one visual degree in size. In comparison to the previous manual and gaze integrated pointing techniques (described for example is U.S. Pat. No. 6,204,828), the present invention may offer numerous advantages, among which are the following.

The prior method based on cursor warping could be disorienting because the cursor appears in a new location without continuity. The present system has continuous cursor movement similar to current display techniques. In addition, prior art methods based on cursor warping are based on the use of a mouse cursor. Consequently, the prior approach does not work on touch screen computers (such as a Tablet computer) where pointing is accomplished by a finger or a stylus, though certain types of touch screens could detect the finger or stylus position before touching the screen, enabling the present system to detect the user's intention of target selection.

The present system checks the eye-gaze position and expands the likely target. Because target expansion can be beneficial even if it occurs rather late in the process of a pointing trial, its requirement of eye-tracking system speed could be lower than a cursor warping pointing method. The latter method requires the tracking effect to be almost instantaneous. Furthermore, it is possible to simultaneously warp the cursor and expand the target, increasing speed of target acquisition even more.

One issue that arises with the present system is that the expansion of one part of the screen results in other parts either being shrunk or hidden completely. In general, hiding part of the screen is undesirable. Hiding is particularly problematic when the area of the screen hidden is near the target, as problems in calibration of the gaze tracking mechanism could cause the intended target to shrink or become invisible. As a result, particular attention must be paid to this problem.

Several approaches may be used to correct for the effects of object expansion such as a geometric approach or a semantic approach. Using a geometric approach to correct for the effects of object expansion, each point on the computer screen is considered the same as any other. A “zoom” transformation is applied to a region around the gaze that causes that region to expand. The expansion can be managed either by simply allowing the transformed or expanded object to overlap onto surrounding objects.

An alternative geometric approach, the displacement approach, shifts or displaces all pixels on the screen, moving the objects on the edge of the screen off the screen display. Yet another alternative geometric approach, the “fish eye” transformation, expands the target region while contracting the regions around the target, leaving objects on the edge of the screen display unaffected.

A further refinement is to use “semantic” information to control the manner by which the screen is transformed. In this case, interactive components of the screen including buttons, scrollbars, hyperlinks, and the like, are treated specially when zooming. These interactive components might be allowed to overlap non-interactive parts of the screen, but not each other. In the present system, interactive components are allowed to overlap non-interactive components. If interactive components conflict, then the “fish-eye” technique is employed.

The present system can also be used in an application to hypertext, as used in web browsers. The layout engine of the web browser can dynamically accommodate changes in the size of particular elements. When the interactive component grows or shrinks, the web browser reformats the document around the resizing component. Most standard web browsers support this functionality of dynamically performing document layout. The manipulation of the screen layout by the web browser is similar to the displacement example, except that, by reformatting the document, the web browser can generally accommodate the resize within a constrained region of the screen.

The present system is applicable to a wider variety of environments than prior systems that are depended on the ability to “warp” a pointer. In a touch screen or a tablet PC environment, or a small hand-held personal digital assistant (PDA), or any application where there is a touch screen with a stylus, the pointer cannot be warped because it is a physical object. The present system is based on physical movement as opposed to cursor or mouse pointer making it applicable to more devices and applications.

The timing of graphical element expansion or “zooming” is very important. If the buttons or other graphical elements were zoomed the instance someone looked at them, this zooming would be very distracting, creating a “distraction effect”. If everywhere a user looked on the screen objects were expanding, the user would be quite distracted. To address this issue, the present system simultaneously determines that there is a gaze fixation on the graphical button or target and that the pointing device is moving toward that target.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a display expansion system of the present invention can be used;

FIG. 2 is comprised of FIGS. 2A, 2B, and 2C, and illustrates several options for handling screen space based on target object expansion by the display expansion system of FIG. 1;

FIG. 3 is comprised of FIGS. 3A, 3B, 3C, and 3D, and illustrates the effect on text, buttons, hyperlinks, etc. by the display expansion system of FIG. 1; and

FIG. 4 is a process flow chart illustrating a method of operation of the display expansion system of FIG. 1.

### DETAILED DESCRIPTION OF PREFERRED EMBODIMENTS

The following definitions and explanations provide background information pertaining to the technical field of the present invention, and are intended to facilitate the understanding of the present invention without limiting its scope:

HTML document: A document marked up in HTML, a standard language for attaching presentation and linking attributes to informational content within documents.

Hyperlink: A link in an HTML document that leads to another web site, or another place within the same HTML document.

Interactive object: An object or element that accepts input from the user through typed commands, voice commands, mouse clicks, or other means of interfacing and performs an action or function as a result of the input.

Fixation: A gaze by a user's eye a particular point at a video screen.

Target: an interactive graphical element such as a button or a scroll bar hyperlink, or non-interactive object such as text which the user wishes to identify through a persistent stare.

Web browser: A software program that allows users to request and read hypertext documents. The browser gives some means of viewing the contents of web documents and of navigating from one document to another.

World Wide Web (WWW, also Web): An Internet client—server hypertext distributed information retrieval system.

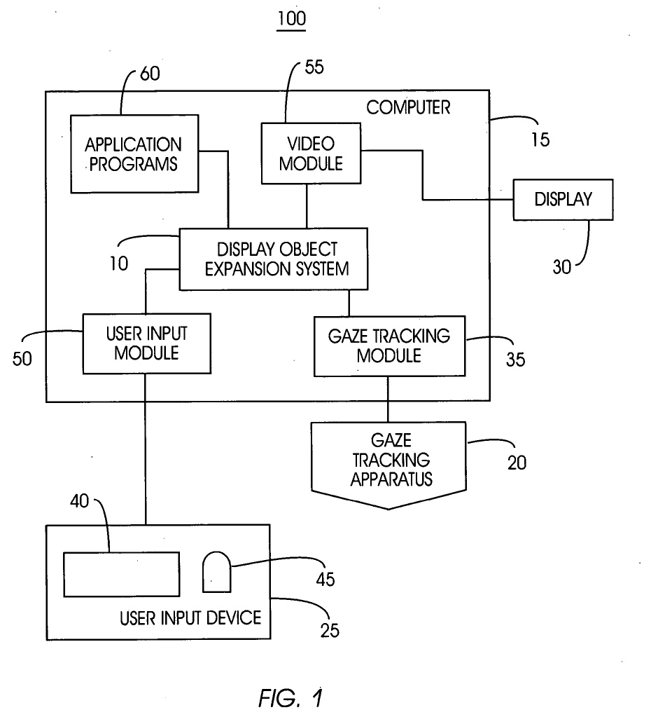

FIG. 1 illustrates an exemplary high-level architecture of an integrated gaze/manual control system 100 comprising a display object expansion and/or contraction system 10 that automatically expands a region of a video screen when system 100 determines that a user has visually selected that region or object. System 10 comprises a software programming code or computer program product that is typically embedded within, or installed on a computer. Alternatively, system 10 can be saved on a suitable storage medium such as a diskette, a CD, a hard drive, or like devices.

Generally, the integrated gaze/manual control system 100 comprises a computer 15, a gaze tracking apparatus 20, a user input device 25, and a display 30. The system 100 may be used, for example, by a “user”, also called an “operator”.

The gaze tracking apparatus 20 is a device for monitoring the eye gaze of the computer operator. The gaze tracking apparatus 20 may use many different known or available techniques to monitor eye gaze, depending upon the particular needs of the application. As one example, the gaze tracking apparatus 20 may employ one or more of the following techniques:
1. Electro-Oculography, which places skin electrodes around the eye, and records potential differences, representative of eye position.
2. Corneal Reflection, which directs an infrared light beam at the operator's eye and measures the angular difference between the operator's mobile pupil and the stationary light beam reflection.
3. Lumbus, Pupil, and Eyelid Tracking. This technique comprises scanning the eye region with an apparatus such as a television camera or other scanner, and analyzing the resultant image.
4. Contact Lens. This technique use some device attached to the eye with a specially manufactured contact lens. With the “optical lever”, for example, one or more plane mirror surfaces ground on the lens reflect light from a light source to a photographic plate or photocell or quadrant detector array. Another approach uses a magnetic sensor in conjunction with contact lenses with implanted magnetic coils.

A number of different gaze tracking approaches are surveyed in the following reference, which is incorporated herein by reference: Young et al., “Methods & Designs: Survey of Eye Movement Recording Methods”, Behavior Research Methods & Instrumentation, 1975, Vol. 7(5), pp. 397-429. Ordinarily, skilled artisans, having the benefit of this disclosure, will also recognize a number of different devices suitable for use as the gaze tracking apparatus 20.

As a specific example of one gaze tracking approach for use in system 100, reference is made to the following patents that are incorporated herein by reference: U.S. Pat. No. 4,836,670 to Hutchison, titled “Eye Movement Detector”; U.S. Pat. No. 4,950,069 to Hutchison, titled “Eye Movement Detector With Improved Calibration and Speed”; and U.S. Pat. No. 4,595,990 to Garwin et al., titled “Eye Controlled Information Transfer”. Although the gaze tracking apparatus 20 may be a custom product, commercially available products may alternatively be used instead.

Although the software programming associated with the gaze tracking apparatus 20 may be included with the gaze tracking apparatus 20 itself, the particular example of FIG. 1 shows the associated software implemented in the gaze tracking module 35, described below. The gaze tracking module 35 may be included solely in the computer 15, in the gaze tracking apparatus 20, or in a combination of the two, depending upon the particular application.

Advantageously, the present invention is capable of accurate operation with inexpensive, relatively low-resolution gaze tracking apparatuses 20. For instance, significant benefits can be gained with gaze tracking accuracy of approximately +/−0.3 to 0.5 degree, which is a low error requirement for gaze tracking systems. With this level of permissible error, the gaze tracking apparatus 20 may comprise an inexpensive video camera, many of which are known and becoming increasingly popular for use in computer systems.

The user input device 25 comprises an operator input device with an element sensitive to pressure, physical contact, or other manual activation by a human operator. This is referred to as “manual” input that “mechanically” activates the user input device 25, in contrast to gaze input from the gaze tracking apparatus 20. As an example, the user input device 25 may comprise one or more of the following: a computer keyboard, a mouse, “track-ball”, a foot-activated switch or trigger, pressure-sensitive transducer stick such as the IBM TRACKPOINT® product, tongue activated pointer, stylus/tablet, touchscreen, and/or any other mechanically activated device.

In the particular embodiment illustrated in FIG. 1, a keyboard 40 and mouse 45 are shown. Although the software programming associated with the user input device 25 may be included with the user input device 25, the particular example of FIG. 1 shows the necessary input device software implemented in the user input module 50, described below. The user input module 50 may be included solely in the computer 15, the user input device 25, or a combination of the two, depending upon the particular application.

The display 30 provides an electronic medium for optically presenting text and graphics to the operator. The display 30 may be implemented by any suitable computer display with sufficient ability to depict graphical images including a cursor. For instance, the display 30 may employ a cathode ray tube, liquid crystal diode screen, light emitting diode screen, or any other suitable video apparatus. The display 30 can also be overlaid with a touch sensitive surface operated by finger or stylus. The images of the display 30 are determined by signals from the video module 55, described below. The display 30 may also be referred to by other names, such as video display, video screen, display screen, video monitor, display monitor, etc. The displayed cursor may comprise an arrow, bracket, short line, dot, cross-hair, or any other image suitable for selecting targets, positioning an insertion point for text or graphics, etc.

The computer 15 comprises one or more application programs 60, a user input module 50, a gaze tracking module 35, system 10, and a video module 55. The computer 15 may be a new machine, or one selected from any number of different products such as a known personal computer, computer workstation, mainframe computer, or another suitable digital data processing device. As an example, the computer 15 may be an IBM THINKPAD® computer. Although such a computer clearly includes a number of other components in addition those of FIG. 1, these components are omitted from FIG. 1 for ease of illustration.

The video module 55 comprises a product that generates video signals representing images. These signals are compatible with the display 30 and cause the display 30 to show the corresponding images. The video module 55 may be provided by hardware, software, or a combination. As a more specific example, the video module 55 may be a video display card, such as an SVGA card.

The application programs 60 comprise various programs running on the computer 15, and requiring operator input from time to time. This input may include text (entered via the keyboard 40) as well as positional and target selection information (entered using the mouse 45). The positional information positions a cursor relative to images supplied by the application program. The target selection information selects a portion of the displayed screen image identified by the cursor position at the moment the operator performs an operation such as a mouse “click”. Examples of application programs 60 include commercially available programs such as database programs, word processing, financial software, computer games, computer aided design, etc.

The user input module 50 comprises a software module configured to receive and interpret signals from the user input device 25. As a specific example, the user input module 50 may include a mouse driver that receives electrical signals from the mouse 45 and provides an x-y output representing where the mouse is positioned. Similarly, the gaze tracking module 35 comprises a software module configured to receive and interpret signals from the gaze tracking apparatus 20. As a specific example, the gaze tracking module 35 may include a program that receives electrical signals from the gaze tracking apparatus 20 and provides an x-y output representing a point where the operator is calculated to be gazing, called the “gaze position”.

As explained in greater detail below, system 10 serves to integrate manual operator input (from the user input module 50 and user input device 25) with eye gaze input (from the gaze tracking apparatus 20 and gaze tracking module 35). System 10 applies certain criteria to input from the gaze tracking apparatus 20 and user input device 25 to determine how objects are shown on the display 30.

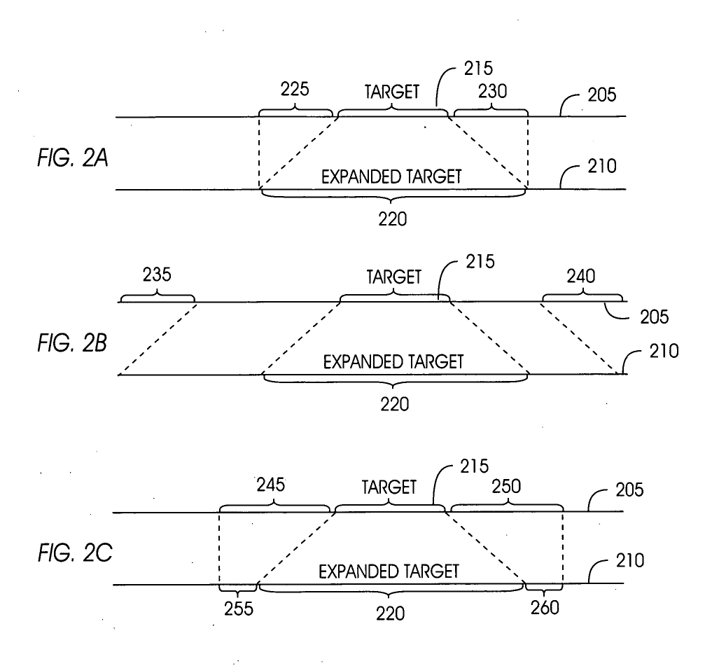

In addition to the hardware environment described above, a different aspect of the present invention concerns a computer-implemented method for selectively expanding and/or contracting a portion of a display using gaze tracking. Since there is a fixed amount of space on the display, expanding a target requires that other objects be either contracted or hidden. FIG. 2 (FIGS. 2A, 2B, 2C) illustrates several options for handling screen space based on geometric expansion. The original screen area 205 is mapped into the 1-dimensional top line. The bottom line represents the transformed screen area 210. The target 215 on the original screen area 205 is mapped to an expanded object 220 on the transformed screen area 210.

FIG. 2A represents an overlapping transformation where the region of the transformed screen 210 around the expanded object 220 is hidden after the expansion occurs. When the size of the target 215 is expanded, any objects or information under the periphery of the target 215 may be hidden. The regions 225, 230 shown in the original screen area 205 are not visible on the transformed screen area 210. The affected part of the screen is limited to the expansion radius of the target 215.

FIG. 2B represents the displacement transformation where all of the contents are shifted when the expansion occurs. In the displacement case, the contents of the original screen area 205 near the borders (regions 235, 240) are hidden or shifted off the edge of the expanded screen area 210 when the target 215 is expanded. All the objects or information on original screen area 205 are shifted by the amount that the target 215 is expanded. An alternative is to provide an empty band around the perimeter of the original screen area 205 to ensure that expansion can occur without information being hidden.

FIG. 2C represents the “fish-eye” transformation that requires that an equivalent contraction also be performed for a given expansion. In the fish-eye approach, regions 245, 250 on the original screen area 205 are contracted to fit into regions 255, 260 on the expanded screen area 210. As in the overlapping case, the region of the expanded screen area 210 outside of regions 255, 260 is unaffected. For a background description of a fish-eye transformation reference is made to Furnas, G. W. (1981) “The FISHEYE View: a new look at structured files” Bell Laboratories Technical Memorandum #81 11221 9.

System 10 may also be used with pages displayed by a web browser. Typical web browsers have their own display layout engines capable of moving objects around the display and choosing optimum layout. As system 10 expands items on the display, the web browser ensures that other objects fit around the expanded target object appropriately.

Possible methods for accomplishing transformations on resulting target 215 comprise a geometric transformation or a semantic transformation. In the geometric transformation, the resulting display image is transformed on a pixel-by-pixel basis without any information about what these pixels represent. In the geometric approach, target expansion is based on the particular pixel gazed at by the user. The target expands centered on the viewed pixel with no regard to object boundaries such as those presented by a button. The overlapping approach, the displacement approach, and the fish-eye approach can be performed using a geometric transformation.

System 10 may use the semantic approach, segmenting the display into interactive elements. Reference is made to “B. B. Bederson and J. D. Hollan. Pad++: A zooming graphical interface for exploring alternate interface physics. In Proceedings of the ACM Symposium on User Interface Software and Technology (UIST′94), pages 17-26. ACM Press, November 1994.”

The location of possible target elements such as buttons, scroll bars, and texts, etc. is used to improve or alter the behavior of the transformation. Of interest during the transformation is the region around the target, the affected region. The parameters of the affected region are determined by the position of the button by system 10. System 10 takes into account that the user is looking at an object, not a pixel, and expands the object itself, not just the region of the display around the pixel. System 10 recognizes that the button or other interactive element is an integral element and expands the whole element in its entirety. Expansion of the object of interest can also be accompanied by the geometric expansion technique, e.g., expanding a picture on a button.

System 10 can determine that the region next to the target contains no part of the target or any other interactive element and then hide that region. If the affected region does not contain any of the target or other interactive element, the button can expand over it and hide that region. However, if the affected region contains an element of interest such as an interactive element, the system could use one of the other transformation approaches such as displacement transformation or fish-eye.

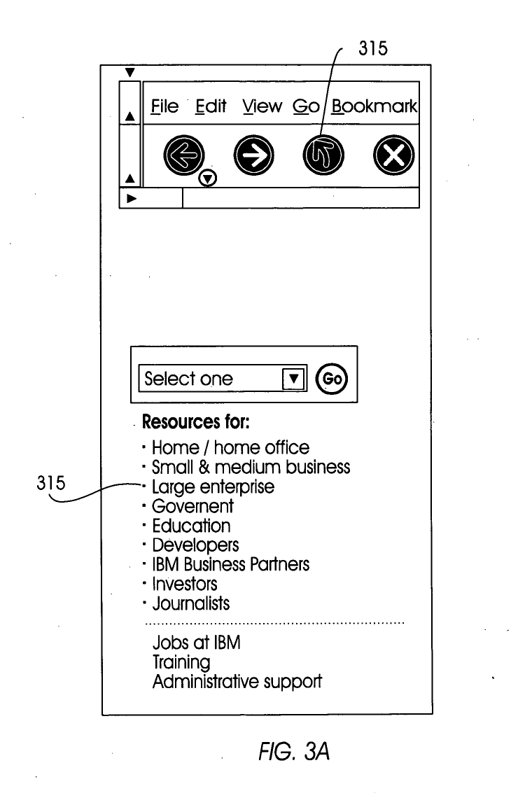

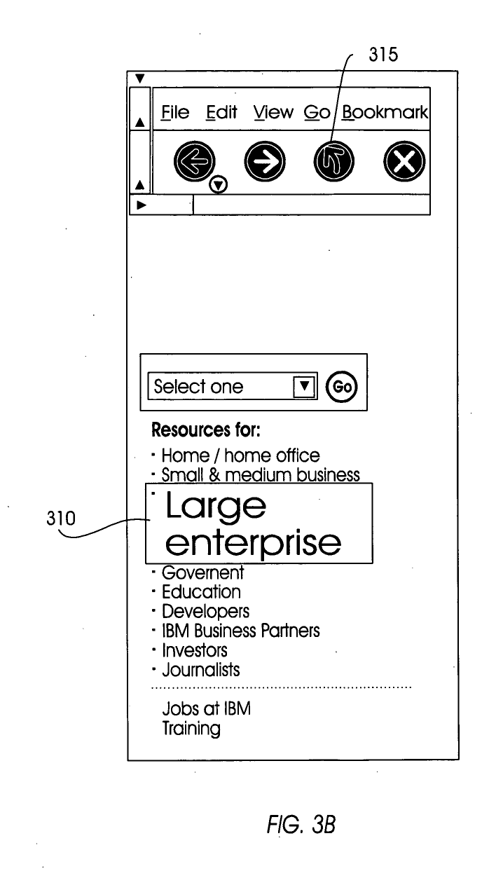

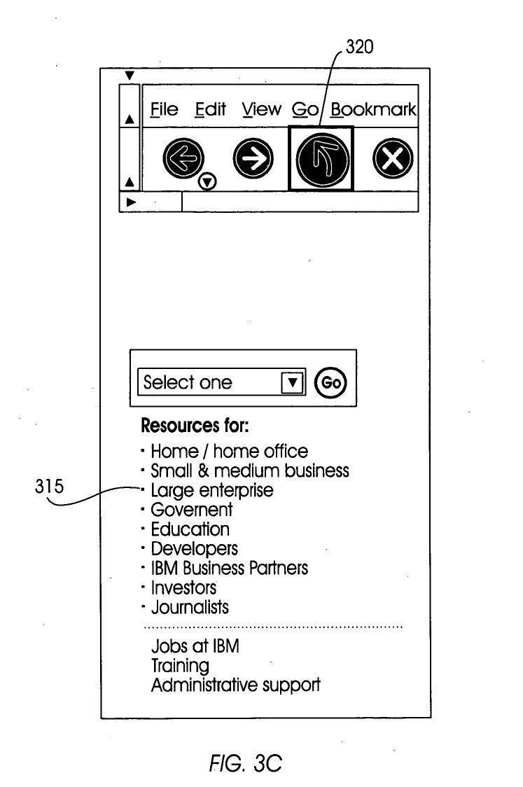

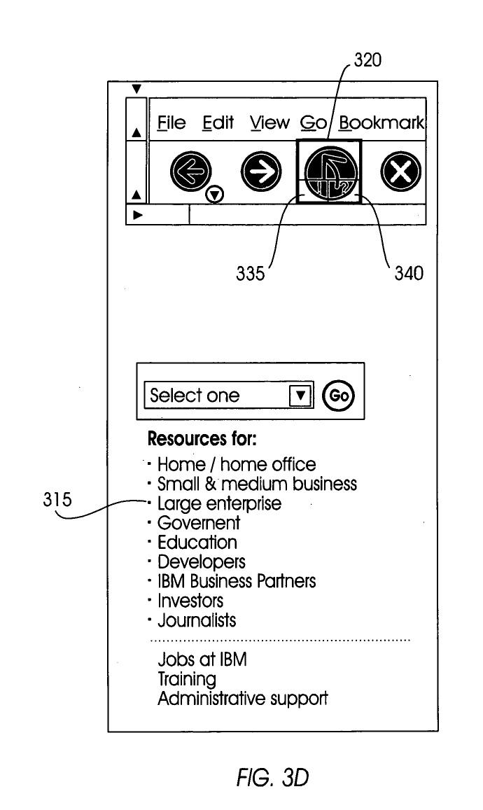

FIG. 3 (FIGS. 3A, 3B, 3C, and 3D) illustrates the effect of system 10 on various target objects such as text, buttons, hyperninks, etc. In FIG. 3A, the target object is text area 305. System 10 expands text area 305 to expanded text area 310 (FIG. 3B). Much as the parameters for a mouse are determined partially in the device, partially in the “driver”, and partially in a control panel, the system's configuration would be divided into preset ranges and user-configurable adjustments.

In FIG. 3B, the target object is button 315. System 10 expands the button to expanded button 320 (FIG. 3C). When using semantic expansion, system 10 recognizes the discreet boundaries of button 315 and only expands the button 315 only, no additional area around button 315.

In FIG. 3D, button 325 initially appears as a single function button. When expanded to expanded button 330, additional functionality may appear in the form of buttons 335, 340. This feature, a semantic zoom, is especially useful for application programs 60 such as relational databases and for displaying file structure, hierarchy, etc.

In addition, semantic zoom can also be used for display window control. Using semantic zoom, system 10 could provide to the user the title of a document and other attributes of a document in response to the user's eye gaze, before the user clicks on the document. When applied to a hyperlink, system 10 could indicate whether the user is likely to get a quick response after clicking on the hyperlink in addition to other attributes of the document link that is currently being gazed. For example, there are several functions that are commonly performed when accessing a hyperlink such as following the link, opening the document the link points to in a new window, downloading the link, etc.

All of these functions may be accessed by system 10 in a multi-function button such as expanded button 330. The expanded button 330 can also be used in a manner similar to “tool tips”, the non-interactive informational notes that may be seen when a user passes a cursor over a button. Advantageously, system 10 provides interactive functions rather than text only, allowing the user to perform an action or function.

System 10 also uses information about the state of the graphical user interface to determine the expansion or contraction of components. For example, inactive or infrequently used components are more likely to contract than expand. In the case where two objects are in close proximity, if the gaze tracker suggests that the user is staring at both objects with equal probability, then the object that has been used most frequently will expand. Likewise, if the difference in probability from the gaze tracker is small, then the preference due to frequency of use can override the small preference from the gaze tracker.

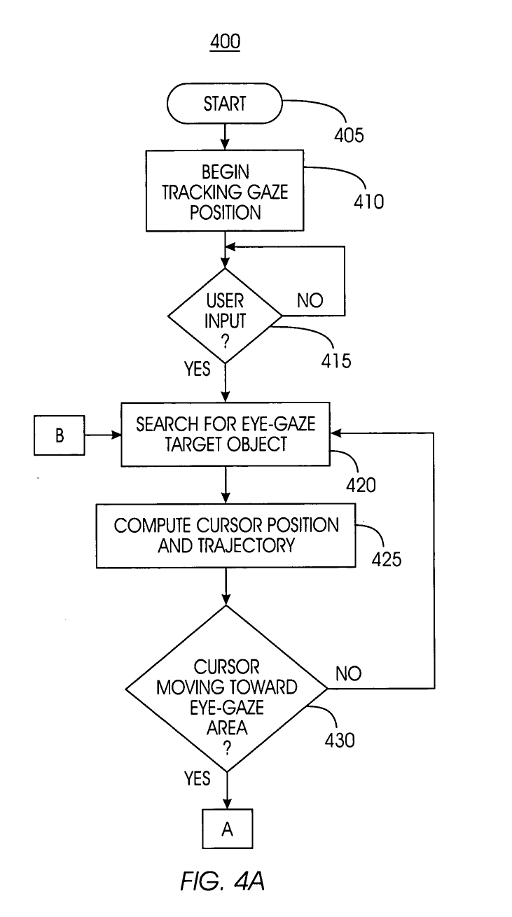

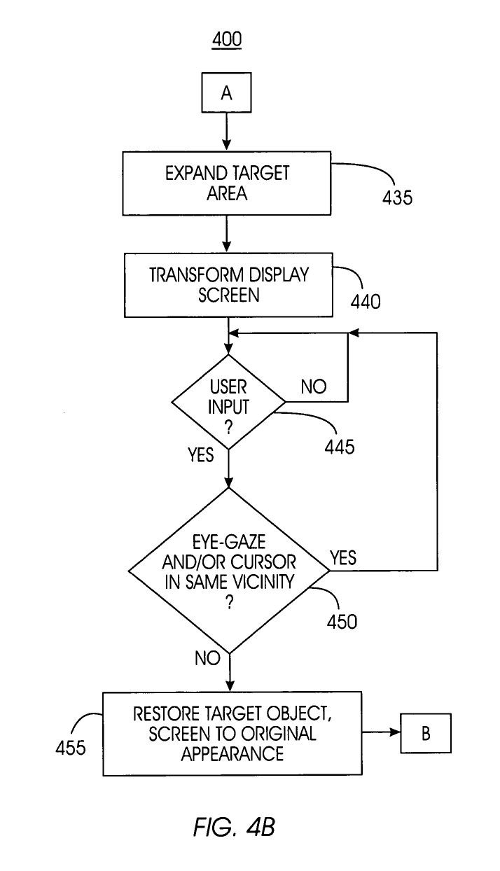

FIG. 4 shows a method 400 of system 10, illustrating one example of the method of the present invention. For ease of explanation, but without any limitation intended thereby, the example of FIG. 4 is described in the context of the hardware environment described above in FIG. 1. The process 400 is initiated in step 405. As an example, this may occur automatically when the computer 15 boots-up, under control of one of the application programs 60, when the operator manually activates the system 10, or at another time.

In response to step 405, the system 10 starts to monitor the operator's gaze position in step 410. The gaze position is a point where the gaze tracking apparatus 20 and gaze tracking module 35 calculate the operator's actual gaze point to be. This calculated point may include some error due to the limits of resolution of the gaze tracking apparatus 20, intrinsic difficulties in calculating gaze (e.g., accounting for head movement in corneal reflection systems, etc.), and other sources of error. These sources of error are collectively referred to as “system noise”, and may be understood by studying and measuring the operation of the system 100. For example, it may be determined in some systems that the error between gaze position and actual gaze point has a Gaussian distribution. As an example, step 410 may be performed by receiving x-y position signals from the gaze tracking module 35.

In step 415, system 10 determines whether there has been any manual user input from the user input device 25. In other words, step 415 determines whether the user input device 25 has been mechanically activated by the user. In the present example, step 415 senses whether the operator has moved the mouse 45 across its resting surface, such as a mouse pad. In a system where a trackball is used instead of the mouse 45, step 415 senses whether the ball has been rolled.

If movement is detected, the system 10 searches for a target object based on the current eye-gaze position at step 420. The “gaze area” is calculated comprising a region that surrounds the gaze position at the time manual user input is received and includes the operator's actual gaze point. As one example, the gaze area may be calculated to include the actual gaze point with a prescribed degree of probability, such as 95%. In other terms, the gaze area in this example comprises a region in which the user's actual gaze point is statistically likely to reside, considering the measured gaze position and predicted or known system noise. Thus, the gaze area's shape and size may change according to cursor position on the display 30, because some areas of the display 30 may be associated with greater noise than other areas.

As a further example, the gaze area may comprise a circle of sufficient radius to include the actual gaze point within a prescribed probability, such as three standard deviations (“sigma”). In this embodiment, the circle representing the gaze area may change in radius at different display positions; alternatively, the circle may exhibit a constant radius large enough to include the actual gaze point with the prescribed probability at any point on the display 30. Of course, ordinarily skilled artisans having the benefit of this disclosure will recognize a number of other shapes and configurations of gaze area without departing from this invention.

At step 425, system 10 computes the cursor position and trajectory. The combination of the cursor position and trajectory with the eye-gaze position enables system 10 to identify the target object. Any of several heuristics may be used to determine whether the movement of the cursor is in the direction of the target object. For example, system 10 may sample over time the distance between the pointer and the target object where the user is currently gazing. If the distance is always getting smaller, then the test for determining whether the object is the target object is true. In an alternate embodiment, system 10 may sample the movement of the cursor at time intervals and compute an approximate line that meets those points, compute an average trajectory, or fit a line to those points.

The combination of determining the movement of the cursor and the timing of graphical element expansion or “zooming” are used to reduce the “distraction effect” on the user. If the buttons or other graphical elements were zoomed the instance someone looked at them, this zooming would be very distracting. Rather than expanding objects any time an eye-gaze was established, the present system simultaneously determines that there is a persistent stare at the graphical button or target and that the pointing device is moving toward that target.

At step 430, system 10 determines whether the cursor is moving toward the eye-gaze area. If the cursor is not moving toward the eye-gaze area, the user is not visually identifying a target object for expansion, and system 10 returns to step 420. If the cursor is moving toward the eye-gaze area, system 10 is able to identify a target object. A natural delay time exists between the moment a user first looks at a button and start to move a cursor toward the button until the user actually click on it. Consequently, even if 90% of the movement has already occurred before system 10 expands the target, there is still significant advantage in time required to acquire or click on the target because system 10 is expanding the target to meet the cursor.

Expansion does not have to happen immediately after the persistent stare is recognized by system 10. Rather, system 10 can wait until wait until, for example, 10% of motion remains or 90% has passed. Consequently, system 10 determines with high probability that the user wishes to click or interact with a particular graphical element, reducing the distraction effect on the user.

System 10 amplifies the target object by a predetermined ratio at step 435 (FIG. 4B). If there are multiple target objects in the gaze area, system 10 amplifies all of them. Objects beyond the gazed area will be transformed in step 440 to accommodate the amplified object. Objects beyond the gazed area may be transformed as in the displacement transformation (FIG. 2B) or fish-eye transformation (FIG. 2C). Alternatively, the amplified target objects may be allowed to cover the objects that are not in the gazed area as in the displacement transformation (FIG. 2A).

Following step 440, system 10 directs normal movement of the cursor according to user input through the user input device 25. Advantageously, the increased size of the target object provided by system 10 allows the user to more quickly select the target object with the cursor.

In one embodiment of the present invention, system 100 may be implemented to automatically recalibrate the gaze tracking module 35. Namely, if the operator selects a target in the gaze area, the selected target is assumed to be the actual gaze point. The predicted gaze position and the position of the selected target are sent to the gaze tracking module 35 as representative “new data” for use in recalibration. The gaze tracking module 35 may use the new data to recalibrate the gaze direction calculation. System 10 may also use this data to update the calculation of the gaze area on the display 30.

The recalibration may compensate for many different error sources. For example, recalibration may be done per user or video display, or for different operating conditions such as indoor use, outdoor use, stationary/moving system operation, etc. Regardless of the way the new data is used by the gaze tracking apparatus 20, the new data may also be used by the system 10 to estimate the size and shape of the gaze area on the display 30. For example, in the system 100, the standard deviation of error can be estimated and updated according to the new data.

The gaze area may also be estimated independently by the application programs 60. For purposes of recalibration and gaze area estimation, the system 100 and the gaze tracking apparatus 20 may maintain and save history and statistics of the new data. This allows profiles to be created and restored for each user, system, operating condition, etc.

The target object remains expanded as long as the system 10 detects user inactivity in step 445. User inactivity may be defined by various conditions, such as absence of mouse input for a predetermined time, such as 100 milliseconds. As another option, inactivity may constitute the absence of any input from all components of the user input device 25. In response to user inactivity, the system 10 keeps displaying the target object expanded and the screen transformed to accommodate the expanded target object.

System 10 then monitors the user input device 25 for renewed activity in step 450. In the illustrated embodiment, renewed activity comprises movement of the mouse 45, representing a horizontal and/or vertical cursor movement or detected movement of the user's eye-gaze. However, other types of renewed activity may be sensed, such as clicking one or more mouse buttons, striking a keyboard key, etc. Despite the end and renewal of user activity, the gaze tracking apparatus 20 and gaze tracking module 35 continues to cooperatively follow the operator's gaze, and periodically recalculate the current gaze position. In response to the renewed activity, the routine 400 progresses from step 450 to step 455, in which the system 10 restores the target object to its original size and display screen to its original appearance. Following step 455, control passes to step 420 (FIG. 4A) and continues with the routine 400 as discussed above.

System 10 expands the target object to increase the ability of the user to acquire a target with a cursor or other pointing device and to increase the speed with which the user acquires the target object. When the target object is expanded, system 10 manages the display of the objects, text, etc. surrounding the target object to minimize distraction to the user and maximize the visibility of the remaining display screen. System 10 can be used concurrently with any system that manipulates cursor movement such as one that takes a mouse pointer and jumps it from one position to another, “warping” the cursor movement.

It is to be understood that the specific embodiments of the invention that have been described are merely illustrative of certain application of the principle of the present invention. Numerous modifications may be made to the system and method for selectively expanding or contracting a portion of a display using eye-gaze tracking invention described herein without departing from the spirit and scope of the present invention.

1. A method of interacting with a monitor, comprising:
modifying a portion of an output displayed on a monitor by tracking an eye gaze and by monitoring an input indicator on the monitor that reflects a user's activity, wherein the output comprises at least part of a target object;
wherein tracking the eye gaze comprises monitoring a user's eye movement in a direction of the target object, and further monitoring a trajectory of the input indicator on the monitor; and
wherein the portion of the output is modified upon detecting the coincidence of the user's eye movement and the input indicator trajectory in the direction of the target object.

2. The method according to claim 1, wherein modifying the portion of the output comprises selectively expanding the portion of the output.

3. The method according to claim 1, wherein modifying the portion of the output comprises selectively contracting the portion of the output.

4. The method according to claim 1, further comprising identifying the target object through eye-gaze tracking.

5. The method according to claim 4, wherein modifying the portion of the output comprises transforming the portion of the output that contains the target object to accommodate any of an expansion or a contraction of the target object.

6. The method according to claim 5, further comprising determining a modification time based on data derived concurrently from the user's eye gaze.

7. The method according to claim 5, further comprising determining a motion direction of the input indicator.

8. The method according to claim 5, wherein identifying the target object is based on data derived concurrently from the eye gaze and the direction of movement of the input indicator.

9. The method according to claim 1, further comprising identifying the portion of the output based on boundaries of interactive graphical user interface components.

10. The method according to claim 9, wherein the interactive graphical user interface components comprise any one or more of a button, a menu, a scrollbar, and a hypertext link.

11. The method according to claim 10, further comprising expanding the interactive graphical user interface components to permit interactivity.

12. The method according to claim 5, wherein the input indicator is inputted by an input device that comprises any one or more of: a mouse, a touch, a touch screen, a tablet computer, a personal digital assistant, a stylus, and a motion sensor.

13. The method according to claim 5, wherein transforming the portion of the output comprises hiding an area of the monitor that is covered by an increase in size of the target object to accommodate a change in appearance of the target object.

14. The method according to claim 5, wherein transforming the portion of the output comprises moving one or more objects on the monitor toward one or more edges of the monitor to accommodate a change in appearance of the target object.

15. The method of claim 5, wherein transforming the portion of the output comprises reducing a size of one or more objects located adjacent the target object to accommodate a change in appearance of the target object while maintaining an original appearance of a remaining portion of the output.

16. The method according to claim 12, further comprising restoring the target object and the monitor to an original appearance when any one of the eye-gaze or the input device indicates that the target object has been deselected.

17. A system for interacting with a monitor, comprising:
means for modifying a portion of an output displayed on a monitor by tracking an eye gaze and by monitoring an input indicator on the monitor that reflects a user's activity, wherein the output comprises at least part of a target object;
wherein tracking the eye gaze is implemented by a means for monitoring an eye movement in a direction of the target object, and by a means for monitoring a trajectory of an input indicator on the monitor; and
wherein the portion of the output is modified upon detecting the coincidence of the user's eye movement and the input indicator trajectory in the direction of the target object.

18. The method according to claim 17, wherein the means for modifying the portion of the output selectively expands the portion of the output.

19. The method according to claim 17, wherein the means for modifying the portion of the output selectively contracts the portion of the output.

20. A software program product having instruction codes for interacting with a monitor, comprising:
a first set of instruction codes for modifying a portion of an output displayed on a monitor by tracking an eye gaze and by monitoring an input indicator on the monitor that reflects a user's activity, wherein the output comprises at least part of a target object;
wherein tracking the eye gaze is implemented by a second set of instruction codes for monitoring an eye movement in a direction of the target object, and by a third set of instruction codes for monitoring a trajectory of an input indicator on the monitor; and
wherein the portion of the output is modified upon detecting the coincidence of the user's eye movement and the input indicator trajectory in the direction of the target object.
